(19) United States
(12) Patent Application Publication
(10) Pub. No.: US 2014/0053892 A1
(43) Pub. Date: Feb. 27, 2014

(54) Solar Cell Plate Having Junction Box Formed Thereon

(71) Applicant: Jin Tae Seol, Changwon-si (KR)

(72) Inventor: Jin Tae Seol, Changwon-si (KR)

(73) Assignee: Hanmyeong Co., Ltd, Gyeongsangnam-do (KR)

(21) Appl. No.: 14/003,435

(22) PCT Filed: Aug. 30, 2011
(86) PCT No.: PCT/KR11/06386

§ 371 Date: Nov. 8, 2013

(30) Foreign Application Priority Data
Mar. 30, 2011 (KR) 10-2011-0028779

(51) Int. Cl. G01R 31/40

(52) U.S. Cl. CPC H02S 50/00
USPC 136/251

(57) ABSTRACT

The present invention relates to a solar cell plate having a junction box formed thereon, the junction box having a housing embedded with a ribbon and a diode, and a cover, which can be attached/detached to/from the housing, and more specifically, to a solar cell plate having a junction box formed thereon, having formed on the cover, a lighting portion having an LED formed thereon, so that the LED in a light-emitting state enables easy confirmation of an abnormality in the solar cell plate.

### TECHNICAL FIELD

The present invention relates to a solar cell plate on which a junction box including a housing having ribbons and diodes embedded therein and a cover attached to and detached from the housing is formed and, more particularly, to a solar cell plate having a junction box formed thereon, wherein a lighting unit having LEDs formed therein is formed in the cover, thereby easily checking whether or not the solar cell plate is abnormal based on the light-emitting state of the LEDs.

### BACKGROUND ART

In solar-light power generation, an electric current generated from a solar cell plate (module) is stored in a charger through a controller, converted into AC power through an inverter, and then used as an electric current for home use.

If the capacity of this solar-light power generation becomes high, a large number of electric wires are necessary in order to extend a line from each solar cell plate and connect to the inverter. In this case, the solar cell plates can be coupled by configuring a junction box functioning as a terminal box in each solar cell plate, and electricity generated from the solar cell plates can be connected to the inverter and the charger through a reduced number of electric wires.

That is, the solar cell plate having this function basically includes a housing, cables, and connectors. The housing of the solar cell plate includes ribbons connected to the solar cell plate and a diode for controlling a flow of an electric current between the ribbons. A cover having a waterproofing function for preventing the infiltration of moisture or impurities is attached to one side of the housing.

A solar cell plate chiefly used in high-capacity solar-light power generation in addition to home use is shown in FIG. 1.

The solar cell plate shown in FIG. 1 includes solar cells arranged in rows of 6 lines and columns of 12 lines, which is commonly indicated by 6*12 columns in standard.

In this solar cell plate, one block includes a row of 2 lines, and the rows are coupled in series and connected to the ribbons of the solar cell plate. That is, + and − electric wires extended from three blocks 1a, 1b, and 1c are connected to four ribbons.

Here, if voltage generated from the middle block 1b is higher than voltage generated from the first block 1a, electricity generated from the middle block 1b can flow from the ribbons 11b and 11c to which the middle block 1b is connected to the ribbons 11a and 11b to which the first block 1a is connected. In order to prevent this flow, a diode 12 functioning as a bypass is formed between the ribbons within the housing 10.

The diode 12 prevents damage to a solar cell by preventing an electric current from flowing in a reverse direction.

The conventional solar cell plate has a structure, such as that of FIGS. 2 to 4. That is, the conventional solar cell plate includes the housing 10 having the ribbons 11 and the diodes 12 embedded therein, the cover 20 fastened to the housing 10 and configured to prevent the infiltration of water or impurities, and the cables 14 and connectors (not shown) connected to the ribbons 11 on one side.

In this solar cell plate, if electricity is not normally generated due to malfunction of the solar cell plate, it is inconvenient for you to open the cover 20 and to check a flow of an electric current between the ribbons 11 of the housing 10 one by one using an inspection device, such as a tester.

That is, in the solar cell plate, one block is connected between the ribbons as described above. In the case of the solar cell plate 1 including the three blocks 1a, 1b, and 1c as in FIG. 1, a flow of an electric current between the ribbons must be checked three times in order to check all the blocks.

Furthermore, the cover 20 is connected to the housing 10 by way of a plurality of hooks 13 and 23 so that the cover 20 is firmly connected to the housing 10 in order to prevent the infiltration of water or impurities. In this case, a task to separate the cover 20 from the housing 10 is not easy.

As a result, in the case of a power generation module in which a plurality of solar cell plates is formed, in order to inspect the solar cell plates due to a reduction of the amount of power generation, the cover 20 of a junction box J formed on each solar cell plate has to be opened, the amount and flow of electricity has to be inspected using a tester, etc., and the cover 20 has to be then connected to the housing 10 again. Accordingly, a lot of time is taken for an inspection, and the inspection task is very inconvenient.

### SUMMARY

### Technical Problem

Accordingly, an object of the present invention is to provide a solar cell plate having a junction box formed thereon, which is capable of checking whether or not a solar cell plate generates electricity even without separating a cover and using an inspection device.

Furthermore, another object of the present invention is to provide a solar cell plate having a junction box formed thereon, wherein whether or not the solar cell plate is normal can be checked by the naked eye because a lighting unit having LEDs formed therein is formed in the solar cell plate and an additional connection member is not necessary because the LEDs directly come in contact with a ribbon or a lead wire formed in the LEDs naturally come in contact with the ribbon when the cover is fixed to the housing.

### Technical Solution

In the present invention, a junction is attached to a solar cell plate, wherein a lighting unit having LEDs formed therein is formed in a cover formed in the junction box so that whether or not the solar cell plate can be checked by the naked eye.

### Advantageous Effects

In the solar cell plate having the junction box formed thereon according to the present invention, whether or not the solar cell plate generates electricity can be checked even without separating the cover, whether or not the solar cell plate is abnormal can be checked by the naked eye because the lighting unit having the LEDs formed therein is formed in the junction box, and an additional connection member is not necessary because the LEDs directly come in contact with the ribbon or the lead wire formed in the LEDs naturally come in contact with the ribbon when the cover is fixed to the housing.

### BRIEF DESCRIPTION OF DRAWINGS

FIG. 1 shows the construction of a common solar cell plate.

FIGS. 2 to 3 show the constructions of a conventional solar cell plate.

FIG. 4 shows the construction of the housing of the conventional solar cell plate.

FIG. 5 is an exemplary diagram showing the construction of the present invention.

FIG. 6 is an exemplary diagram showing the construction of the present invention from which one part has been deleted.

FIG. 7 is an exemplary diagram of another embodiment of the present invention.

FIG. 8 is an exemplary diagram of yet another embodiment of the present invention.

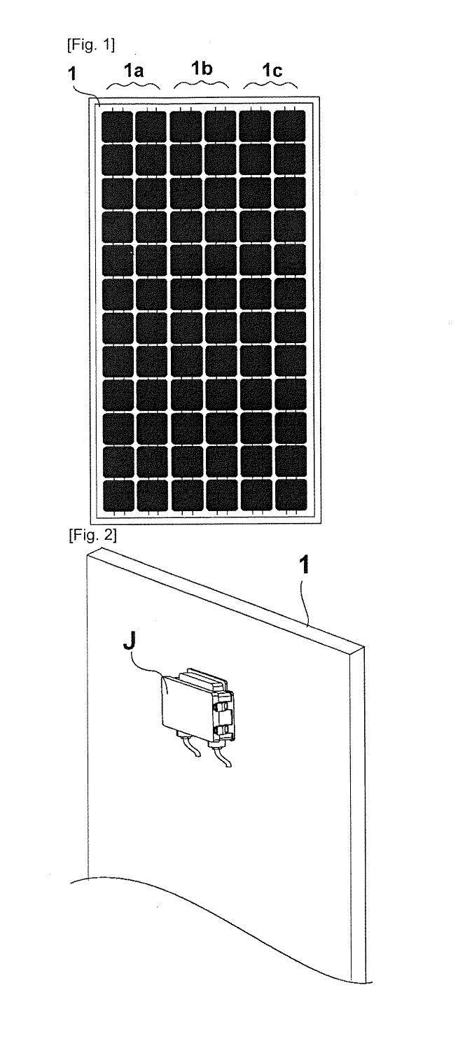

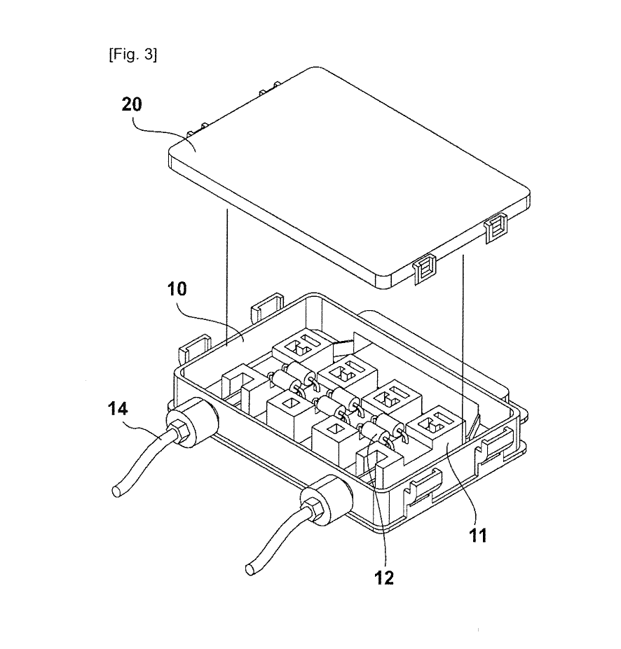

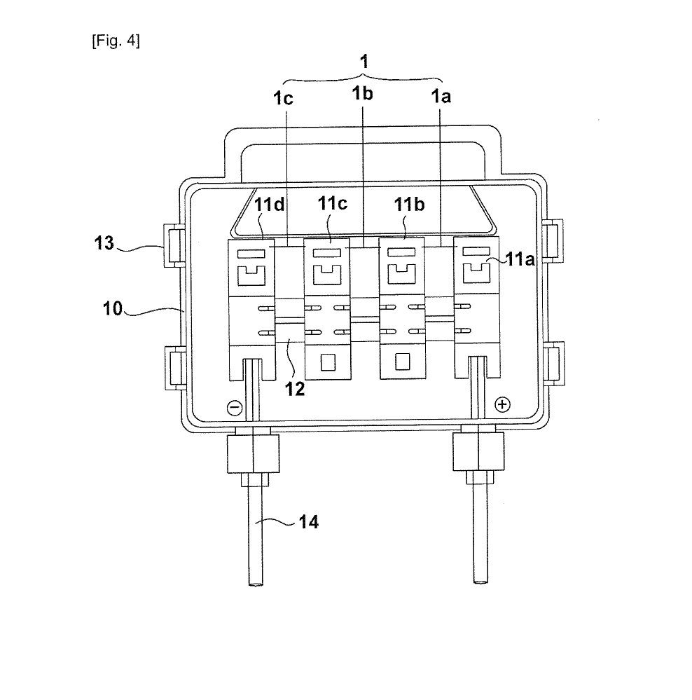

<Description of reference numerals of principal
elements in the drawings>

| | | |
|---|---|---|
| 1. solar cell plate | | |
| 1a. (solar cell plate) first block | | |
| 1b. (solar cell plate) middle block | | |
| 1c. (solar cell plate) last block | | |
| 10. housing | 11. ribbon | 12. diode |
| 13. hook | 14. cable | |
| 20. cover | 20a. (cover) upper | |
| | side | |
| 20b. (cover) back side | | |
| 21. lighting unit | 22. LED | 22a. lead wire |
| 23. hook | 24. transparent | |
| | cover | |
| J. solar cell plate | | |

### DETAILED DESCRIPTION OF EMBODIMENTS OF INVENTION

The present invention relates to a solar cell plate on which a junction box including a housing having ribbons and diodes embedded therein and a cover attached to and detached from the housing is formed and, more particularly, to a solar cell plate having a junction box formed thereon, wherein a lighting unit having LEDs formed therein is formed in the cover, thereby easily checking whether or not the solar cell plate is abnormal based on the light-emitting state of the LEDs.

A preferred embodiment of the present invention is described in detail below with reference to the accompanying drawings.

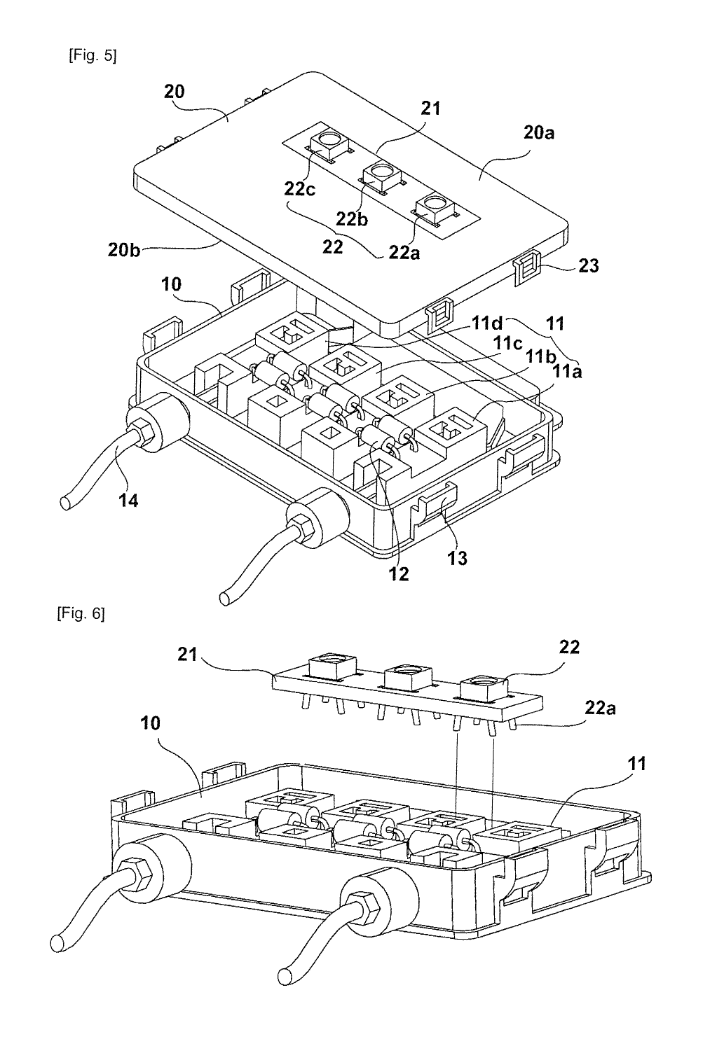

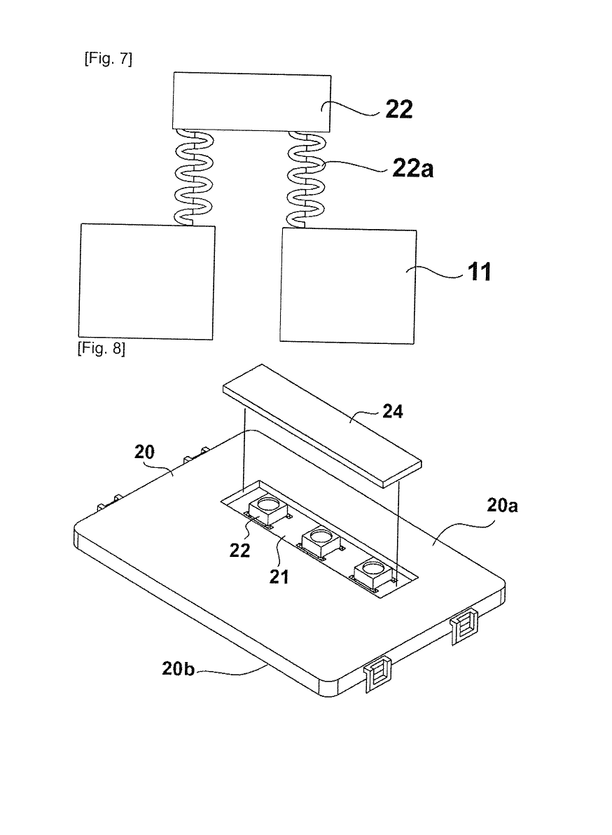

FIG. 5 is an exemplary diagram showing the construction of the present invention, FIG. 6 is an exemplary diagram showing the construction of the present invention from which one part has been deleted, and FIG. 7 is an exemplary diagram of another embodiment of the present invention. In the solar cell plate having a junction box formed thereon according to the present invention, in the solar cell plate on which the junction box including a housing 10 attached to the back side of the solar cell plate 1 and configured to have ribbons 11 and diodes 12 embedded therein and a cover 20 attached to and detached from the housing 10 is formed, a lighting unit 21 having LEDs 22 formed therein is formed on the upper side 20a of the cover 20, so whether or not the solar cell plate 1 is abnormal can be checked by the naked eye.

First, like the housing of a conventional solar cell plate, the housing 10 is attached to the back side of the solar cell plate 1 and configured to have the ribbons 11 and the diodes 12 embedded therein. The number of ribbons 11 can be different depending on the number of solar cells formed in the solar cell plate and the number of blocks 1a, 1b, and 1c for dividing the solar cells.

The cover 20 is attached to and detached from the housing 10. In the illustrated embodiment, the cover 20 and the housing 10 are coupled using hooks 13 and 23, and a necessary number of the hooks 13 and 2 are formed in order to maintain airtightness.

Furthermore, packing preferably is connected to the cover 20 in order to further increase airtightness between the housing 10 and the cover 20.

The lighting unit 21 having the LEDs 22 formed therein is formed on the upper side 20a of the cover 20, that is, a surface that is externally exposed when the cover 20 is connected to the housing 10, so that whether or not the solar cell plate 1 is abnormal, that is, whether or not the solar cell plate 1 generates electricity, can be checked by the naked eye. The number of LEDs 22 formed in the lighting unit 21 preferably is equal to the number of ribbons 11 from which 1 is subtracted.

A surface opposite to the upper side 20a of the cover 20, that is, a surface that faces the housing, is the back side 20b of the cover. The emission of the LEDs 22 needs to be displayed externally through the back side 20b. The LEDs 22 need to be brought in contact with the ribbons 11, lead wires, etc. which are contained in the housing 10.

Furthermore, the LEDs 22 may be formed of one fasting part coupled with the cover 20 as shown in FIGS. 5 and 6, or the LEDs 22 may be formed to be separately coupled with the cover 20.

When the cover 20 and the housing 10 are coupled, the LEDs 22 are brought in contact with one side of the ribbons 11. Thus, when an electric current flows between the ribbons 11, the LEDs 22 are configured to emit light. The LEDs 22 may be formed in such a way as to directly come in contact with the ribbons 11, or lead wires 22a may be formed in the LEDs 22 in such a manner that the lead wires 22a come in contact with the ribbons 11.

Furthermore, the lead wires 22a may be formed in a spring form as in FIG. 7, so that contact force between the lead wires 22a and the ribbons 11 is increased when the cover 20 is coupled with the housing 10 in a compression state.

In the case of the lighting unit 21 shown in FIG. 5, if an electric current does not normally flow in a No. 2 ribbon 11b and a No. 3 ribbon 11c, an LED 22b brought in contact between the Nos. 2 and 3 ribbons does not emit light. Accordingly, if a user has only to inspect and repair only the middle block 1b formed in the middle of the solar cell plate, normal power generation is possible and thus the time taken for an inspection can be reduced.

If all the LEDs 22 are not turned on even when solar light is applied to the solar cell plate 1, a repair task to replace the solar cell plate, etc. can be performed because the solar cell plate 1 itself does not normally generate electricity.

FIG. 8 is an exemplary diagram of yet another embodiment of the present invention, wherein the lighting unit 21 having the LEDs 22 formed therein is embedded in the cover 20. In this embodiment, a transparent cover 24 can be formed outside the lighting unit 21 in order to prevent the infiltration of water or impurities. If an LED of a chip form (CMD type LED) is used, resin can be filled in order to eliminate air that remains between the transparent cover 24 and the LEDs 22.

The resin preferably has transparent color basically in order to increase the penetrability of light emitted from the LEDs.

1. A solar cell plate on which a junction box comprising a housing 10 attached to a back side of the solar cell plate 1 and configured to have ribbons 11 and diodes 12 embedded therein and a cover 20 attached to and detached from the housing 10 is formed,
wherein a lighting unit 21 having LEDs 22 formed therein is formed on an upper side 20a of the cover 20 so that whether or not the solar cell plate 1 is abnormal is checked by a naked eye, and
when the cover 20 and the housing 10 are coupled, the LEDs 22 formed in the lighting unit 21 come in contact with the ribbons 11 and emit light when an electric current flows between the ribbons 11.

2. The solar cell plate of claim 1, wherein:
the lighting unit 21 is formed in such a way as to be embedded in the cover 20, and
a transparent cover 24 is formed outside the lighting unit 21 in order to prevent an infiltration of moisture.

3. The solar cell plate of claim 1, wherein:
the LEDs 22 come in contact with the ribbons 11 by way of lead wires 22a formed on one side of the LEDs 22, and
the lead wires 22a are formed in a spring form so that the cover is compressed and brought in contact with the housing when the cover is coupled with the housing, thereby increasing contact force between the lead wires 22a and the ribbons 11.

4. The solar cell plate of claim 1, wherein:
the lighting unit 21 is formed in such a way as to be embedded into the cover 20,
a transparent cover 24 for preventing an infiltration of water or impurities is formed outside the lighting unit, and
resin is filled into a space between the transparent cover 24 and the LEDs 22.
